(19) United States
(12) Patent Application Publication
(10) Pub. No.: US 2005/0244131 A1
(43) Pub. Date: Nov. 3, 2005

(54) Electronic apparatus and display control method

(75) Inventor: Keiichi Uehara, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/088,816

(22) Filed: Mar. 25, 2005

(30) Foreign Application Priority Data
Apr. 28, 2004 (JP) JP2004-134495

(51) Int. Cl. H04N 5/76; H04N 5/781

(52) U.S. Cl. 386/46; 386/125

(57) ABSTRACT

An electronic apparatus includes a display device, a display controller which outputs a first video signal to be displayed on the display device, and an image processing controller which performs video quality processing on the video signal generated by the display controller and outputs a second video signal to be displayed on the display device.

### CROSS-REFERENCE TO RELATED APPLICATIONS

This application is based upon and claims the benefit of priority from prior Japanese Patent Application No. 2004-134495, filed Apr. 28, 2004, the entire contents of which are incorporated herein by reference.

### BACKGROUND OF THE INVENTION

1. Field of the Invention

The present invention relates to an electronic apparatus having a function of processing display data to a high-quality image and a display control method of the same.

2. Description of the Related Art

In recent years, a personal computer (PC) having functions similar to those of a DVD player and a television set has come on the market.

For example, Jpn. Pat. Appln. KOKAI Publication No. 2002-108486 (FIG. 5, etc.) discloses a PC mounted with a DVD driver and a TV tuner. According to this publication, a video signal obtained from the TV tuner or the like is processed by an image controller and thereafter displayed on a display section directly connected to the image controller.

The above publication also discloses a technique of switching between a PC mode, in which an OS is activated to perform a personal computer function, and an AV mode, in which AV function software is activated to perform an AV function. The use of the AV mode makes it possible, for example, to boot up application software for watching TV programs and display an electronic program guide in a sub-display section.

To enjoy fully high-quality image by making use of the functions of the DVD driver and the TV tuner, means for forming a high-quality image is required. However, the above publication does not disclose such means.

If means for forming a high-quality image is provided in the PC disclosed in the above publication, the power consumption of the PC will be increased. Also, a time for initialization and a setting process will be required before starting high-quality image display.

Under the circumstances, there is a demand for presenting an electronic apparatus, which can display a high-quality image and the operability of which is improved, and a display control method of the same.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an exterior of an electronic apparatus according to an embodiment of the present invention;

FIG. 2 is a block diagram showing a configuration of the electronic apparatus of the embodiment;

FIG. 3 is a diagram showing programs, etc. stored in a memory of the electronic apparatus;

FIG. 4 is a diagram showing an example of a setting screen;

FIG. 5 is a flowchart showing a basic operation of the electronic apparatus; and

FIG. 6 is a flowchart showing an operation relating to prohibition of switching between display modes.

### DETAILED DESCRIPTION OF THE INVENTION

Embodiments of the present invention will be described below with reference to the drawings.

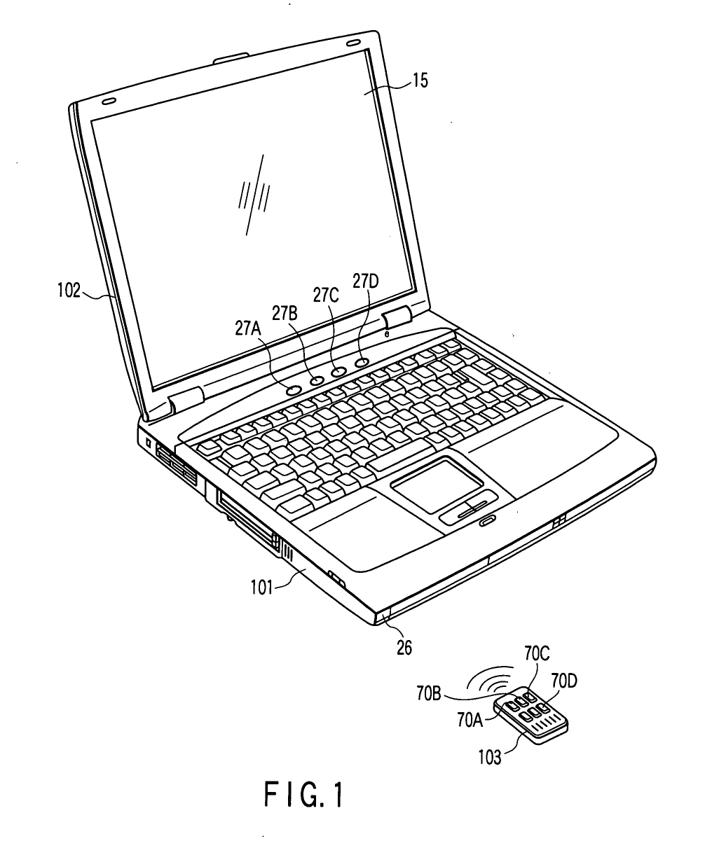

FIG. 1 is a perspective view showing an exterior of an electronic apparatus according to the embodiment of the present invention.

The electronic apparatus is, for example, a personal computer (PC), which includes an apparatus main body 101 and a display device 102. The display device 102 includes a liquid crystal display (LCD) 15 to display information. The apparatus main body 101 includes an infrared ray (IR) receiving section 26, a power switch 27A, a DVD switch 27B, a TV switch 27C, a display mode change switch 27D, etc. The IR receiving section 26 receives an infrared signal transmitted from a remote controller 103 operated by a user.

The remote controller 103 is as an accessory of the electronic apparatus. It has a power switch 70A, a DVD switch 70B, a TV switch 70C and a display mode change switch 70D, which have the same functions as those of the power switch 27A, the DVD switch 27B, the TV switch 27C and the display mode change switch 27D, respectively.

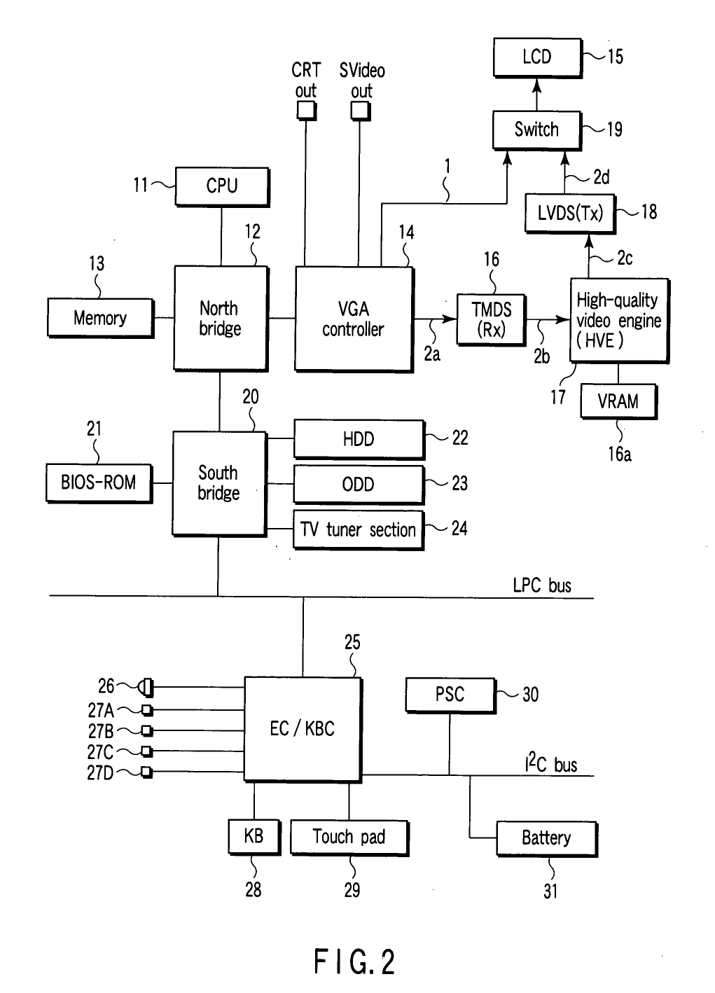

FIG. 2 is a block diagram showing a configuration of the electronic apparatus of the embodiment. The same elements as those in FIG. 1 are denoted by the same reference numerals.

A CPU 11 is a processor, which controls the overall electronic apparatus. It executes various processes in accordance with programs, for example.

A north bridge 12 is a bridge device, which has an interface function with respect to the CPU 11, a hub interface function with respect to a south bridge 20, a function of controlling a memory 13 and a function of controlling a VGA controller 14.

A memory 13 is a main memory, which stores an operating system (OS), various programs and drivers. It is used as a work area of the CPU 11.

The VGA controller 14 incorporates a video random access memory (VRAM) to read and write video graphic data, and an LVDS (Tx) processing section to generate an LVDS signal. It generates a video signal (normally, an LVDS signal), which can be displayed in the display device (LCD 15 or the like) in accordance with a signal supplied from the north bridge 12, and outputs the generated video signal to a line 1 or 2a. The VGA controller 14 is connected to an interface to output the video signal to a cathode ray tube (CRT) or an interface to output an S video signal.

The LCD 15 includes an LVDS (Rx) processing section, which processes a low voltage differential signaling (LVDS) signal. It displays information such as an image based on the LVDS signal transmitted from the VGA controller 14 or a high-quality video engine 17 via a switch 19, etc.

A TMDS (Rx) processing section 16 converts, to a digital signal, a 24-bit RGB signal (i.e., transition minimized differential signaling (TMDS) signal) transmitted from the VGA controller 14 through the line 2a, and outputs the digital signal to the line 2b.

The high-quality video engine (HVE) 17 includes a VRAM 16a. It subjects a 24-bit RGB signal transmitted from the TMDS (Rx) processing section 16 through the line 2b to an image process to improve the image quality (mainly to improve the sharpness, correct the color and increase the response speed). Then, the high-quality video engine 17 converts the signal to an 18-bit RGB signal and outputs it to a line 2c.

An LVDS (Tx) processing section 18 converts, to an LVDS signal, the 18-bit RGB signal transmitted from the high-quality video engine 17 through the line 2c, and outputs the LVDS signal to the line 2d.

The switch 19 is controlled by a BIOS or the like to switch between the signals transmitted through the lines 1 and 2d to be input thereto. It outputs the received signal to the LCD 15.

The south bridge 20 is a bridge device, which has a hub interface function with respect to the north bridge 12, a function of controlling various devices connected thereto, a function of controlling a low pin count (LPC) bus and a function of controlling a peripheral component interconnect (PCI) bus.

A BIOS-ROM 21 is a memory, which stores a basic input/output system (BIOS).

A hard disk drive (HDD) 22 stores an OS, various programs and data.

An optical disk drive (ODD) 23 drives a digital versatile disk (DVD) or the like storing video contents, etc.

A TV tuner section 24 includes a TV tuner, a national television system committee/phase alternation by line (NTSC/PAL) decoder, an MPEG2 encoder, an antenna, etc., and acquires TV video contents.

An embedded controller/keyboard controller (EC/KBC) 25 is formed integrally of an embedded controller (EC) and a keyboard controller. It manages power supply and processes a signal from an input device.

The EC manages the power supply to elements in the electronic apparatus based on various information stored in internal registers. For example, the EC controls a power supply state, a power saving state and a power supply stop state of the circuit elements 16 to 18 in accordance with a designated display mode (to be described later). The EC also detects the depression of the switches 27A, 27B, 27C and 27D and the switches 70A, 70B, 70C and 70D on the remote controller 103 via the receiving section 26, and carries out the corresponding process or supplies the corresponding instructions to the related section.

The receiving section 26 receives a signal representing the depression of the switches 70A, 70B, 70C and 70D on the remote controller 103, and transmits it to the EC/KBC 25.

The power switch 27A is a switch to turn on or off the power supply of the electronic apparatus main body. The DVD switch 27B is a switch to start or stop playing back a DVD driven by the ODD. The TV switch 27C is a switch to start or stop receiving TV images by the TV tuner section 24. The display mode change switch 27D is a switch to instruct switch between high-quality image display and normal display.

A keyboard 28 and a touch pad 29 are input devices to supply a signal in accordance with an input operation to the KBC.

A power supply controller (PSC) 30 controls power to be supplied to the elements in the electronic apparatus. It is controlled by the EC via an I²C bus. A battery 31 is a rechargeable battery. It is used when the AC power supply is not used.

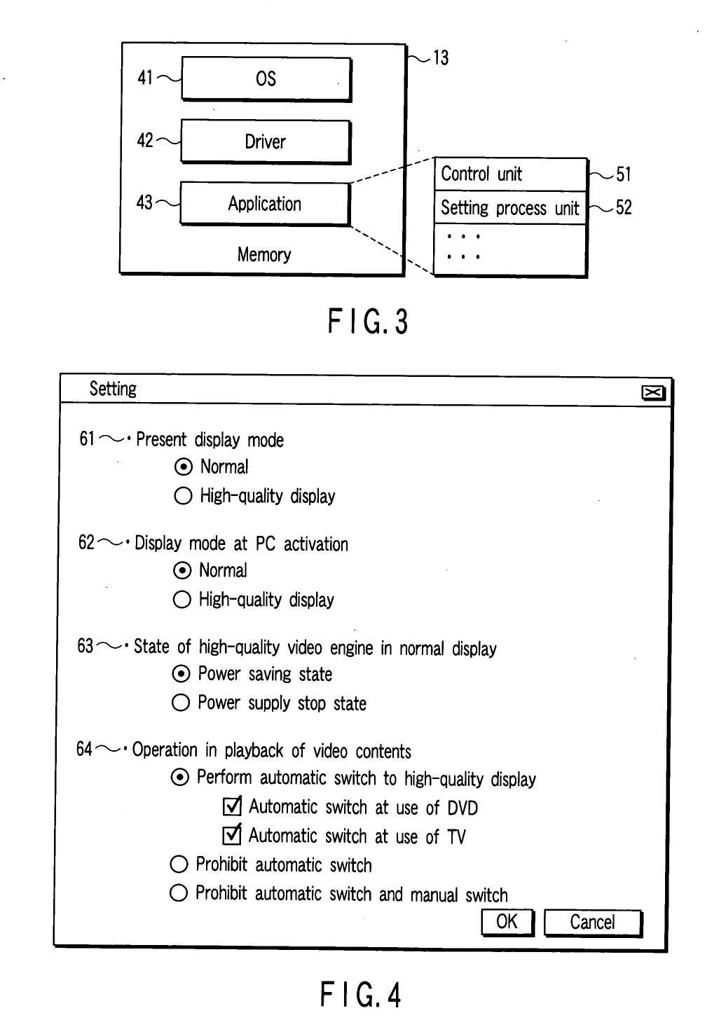

FIG. 3 is a diagram showing programs, etc. stored in the memory 13 of the electronic apparatus.

As shown in FIG. 3, the memory 13 stores an OS 41, a driver 42 and an application 43 executed by the CPU. The application 43 includes a control unit 51 and a setting process unit 52.

The control unit 51 switches between a first display mode (hereinafter referred to as a normal mode) and a second display mode (hereinafter referred to as a high-quality mode). In the normal mode, a video signal generated by the VGA controller 14 is transmitted to the LCD 15 without passing through the high-quality video engine 17, etc. In the high-quality mode, the video signal is transmitted to the LCD 15 via the high-quality video engine 17, etc.

For example, when starting or stopping display of video contents played back from a DVD or acquired through the TV tuner, the control unit 51 switches between the high-quality mode and the normal mode. When the display mode change switch 27D or the corresponding switch 70D on the remote controller is depressed, the control unit 51 also switches between the high-quality mode and the normal mode.

The setting process unit 52 performs a setting process relating to the display mode based on information input by the user through the setting screen on the LCD 15. FIG. 4 shows an example of the setting screen.

As shown in FIG. 4, the setting screen includes a plurality of setting items 61 to 64.

The setting item 61 is provided to designate whether the present display mode should be the normal mode or the high-quality mode.

The setting item 62 is provided to designate whether the display mode at the time of activating the electronic apparatus should be the normal mode or the high-quality mode.

The setting item 63 is provided to designate whether the high-quality video engine 17, the TMDS (Rx) processing section 16 and the LDVS (Tx) processing section 18 should be the power saving state or the power supply stop state, when the electronic apparatus is operated in the normal mode.

The setting item 64 is provided to designate whether automatic switching to the high-quality mode should be performed or not when video contents are to be displayed. When setting the automatic switching, it is also possible to designate whether or not the automatic switching is to be performed when the DVD is used and to designate whether or not the automatic switching is to be performed when the TV is used. It is possible to set the automatic switching not to be permitted, in which case only manual switching (operation of the display mode change switch 27D or input of the item 61) is permitted. Further, it is possible to set neither the automatic switching nor the manual switching to be permitted.

After necessary information is input on the setting screen, when an OK button is depressed, the set contents are stored in a predetermined memory area. The stored set contents can be used by the BIOS when activating the electronic apparatus, or by the control unit 51 which is operated under the OS in the normal operation.

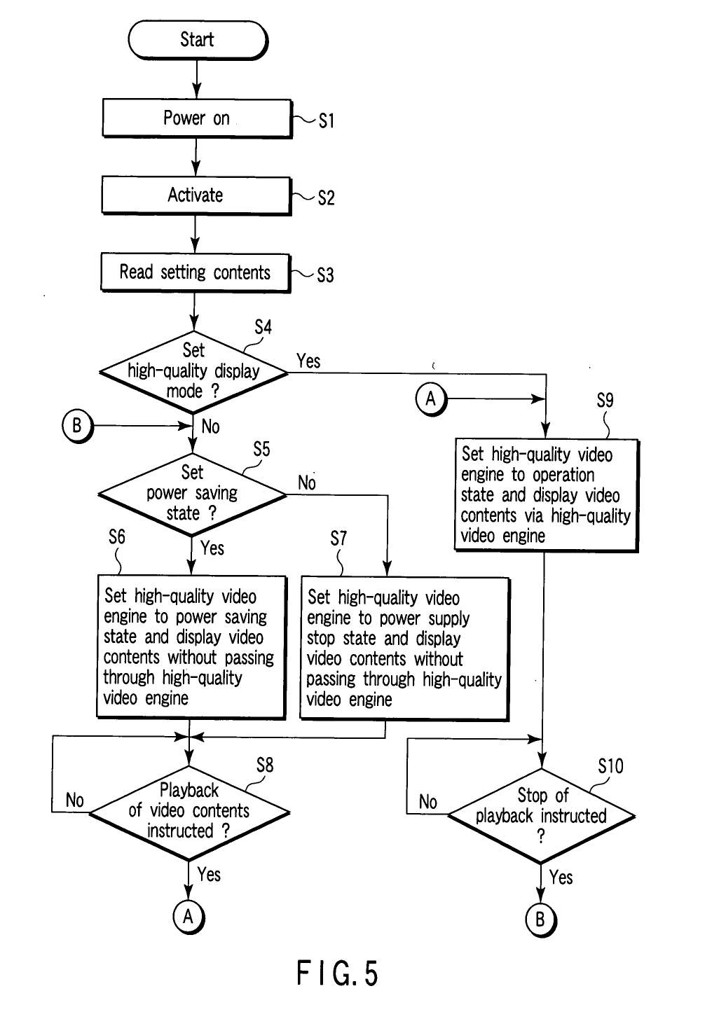

A basic operation will now be described with reference to FIG. 5. In the following description, it is assumed that the electronic apparatus is set in advance so that the display mode is switched automatically.

For example, when the user operates the power switch 27A of the electronic apparatus, the power is turned on (step S1) and the system is activated (step S2).

The BIOS or the control unit 51 (hereinafter referred to as the control unit) reads the set contents stored in a predetermined memory area (step S3), and determines whether to set the normal display mode or the high-quality display mode based on the set contents (step S4).

If the normal display mode is to be set, the control unit determines whether the high-quality video engine 17, the TMDS (Rx) processing section 16 and the LVDS (Tx) processing section 18 (hereinafter referred to as the high-quality video engine 17 and the like) should be set to the power saving state or the power supply stop state based on the set contents (step S5).

If the power saving state is to be set, the control unit turns the high-quality video engine 17 and the like to the power saving state, so that the video signal can be sent from the VGA controller 14 to the LCD 15 without passing through the high-quality video engine 17 and the like (step S6). If the power supply stop state is to be set, the control unit sets the high-quality video engine 17 and the like to the power supply stop state, so that the video signal can be sent from the VGA controller 14 to the LCD 15 without passing through the high-quality video engine 17 and the like (step S7).

Then, when playback of the video contents obtained from the DVD or the TV is instructed (step S8), the control unit supplies power to cause the high-quality video engine 17 and the like to perform the normal operation. In this case, the video signal is supplied from the VGA controller 14 to the LCD 15 via the high-quality video engine 17 and the like (step S9).

Thereafter, when stop of the playback of the video contents is instructed (step S10), the control unit sets the high-quality video engine 17 and the like to the power saving state or the power supply stop state, as indicated in step S5 and the subsequent steps. In this case, the video signal is supplied from the VGA controller 14 to the LCD 15 without passing through the high-quality video engine 17 and the like.

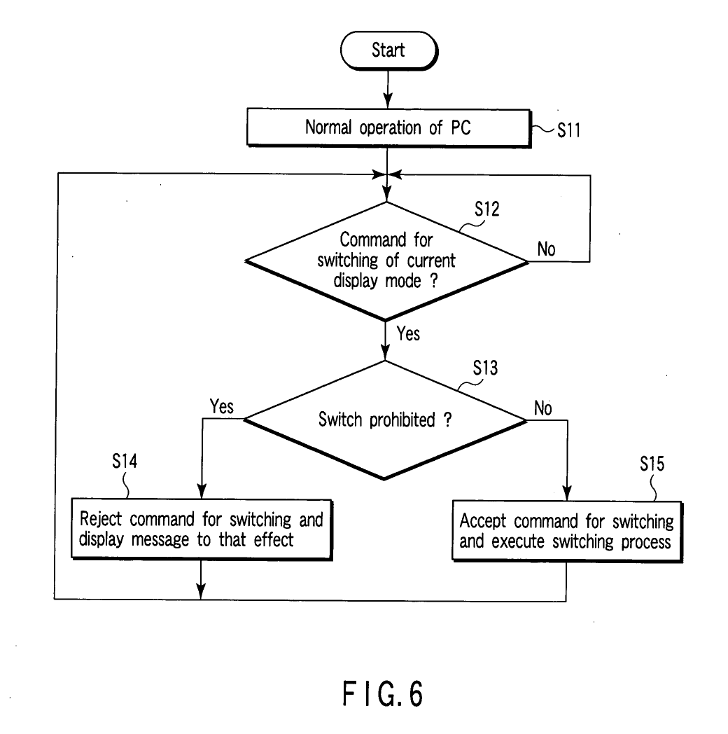

Next, an operation of prohibition of switching between display modes will be described with reference to FIG. 6.

When the electronic apparatus is performing a normal operation (step S11), the control unit is monitoring whether there is a command for an automatic (or manual) switching of the current display mode (step S12).

If there is a command for switching, the control unit determines whether the switching is prohibited or not based on the set contents stored in the predetermined memory area (step S13).

If the switching is prohibited, the control unit rejects the command for switching and causes the LCD 15 to display a message to that effect (for example, “Switching of the display mode is not permitted”) (step S14). On the other hand, if the switching is permitted, the control unit accepts the command and executes the switching process (step S15).

As described above, according to the embodiment, the display mode can be switched automatically or manually as the user desires, during the activation or normal operation of the electronic apparatus. Therefore, if high-quality display is not required, the power can be saved. Thus, the operability of the electronic apparatus for the user is increased.

In addition, when the high-quality display is not necessary, the high-quality video engine and the like can be set to the power saving state in advance. Therefore, when the high-quality display becomes necessary, the high-quality video engine and the like can be immediately shifted to the normal operation mode. Therefore, playback of the video contents can be started at once.

Further, switching of the display mode can be set to be impossible (prohibited). Therefore, the user can use the electronic apparatus such that, for example, importance is attached to the power saving or the high-quality display.

As has been described above in detail, it is possible to display a high-quality image and improving the operability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus, comprising:
a display device;
a display controller which outputs a first video signal to be displayed on the display device; and
an image processing controller which performs video quality processing on the video signal generated by the display controller and outputs a second video signal to be displayed on the display device.

2. The electronic apparatus according to claim 1, wherein the image processing controller performs high-quality video processing on the video signal generated by the display controller, and
the electronic apparatus further comprising a control unit which switches between a first display mode in which the video signal generated by the display controller is supplied to the display device without passing through the image processing controller and a second display mode in which the video signal generated by the display controller is supplied to the display device via the image processing controller.

3. The electronic apparatus according to claim 2, wherein the control unit executes the first display mode, when the electronic apparatus is activated.

4. The electronic apparatus according to claim 2, wherein the control unit causes the image processing controller to be in a power saving state, when the first display mode is executed.

5. The electronic apparatus according to claim 2, wherein the control unit switches the first display mode to the second display mode, when video contents are to be displayed.

6. The electronic apparatus according to claim 2, wherein the control unit switches between the first display mode and the second display mode in accordance with an input operation.

7. The electronic apparatus according to claim 2, further comprising a setting unit which designates one of the first display mode and the second display mode to be executed when the electronic apparatus is activated,
wherein the control unit executes the display mode that is indicated by the designation of the setting unit, when the electronic apparatus is activated.

8. The electronic apparatus according to claim 2, further comprising a setting unit which designates whether the image processing controller is to be set to a power saving state or a power supply stop state when the first display mode is executed,
wherein the control unit causes the image processing controller to be set to a state that is indicated by the designation of the setting unit, when the first display mode is executed.

9. The electronic apparatus according to claim 2, further comprising a setting unit which designates whether or not the first display mode is to be switched to the second display mode when video contents are to be displayed,
wherein the control unit performs control in accordance with the designation of the setting unit, when video contents are to be displayed.

10. The electronic apparatus according to claim 2, further comprising a setting unit which designates whether switching between the first display mode and the second display mode is to be prohibited or not,
wherein the control unit performs control in accordance with the designation of the setting unit.

11. A display control method applied to an electronic apparatus having a display device capable of displaying data, the method comprising:
generating a video signal to be displayed on the display device by a display controller; and
switching between a first display mode in which the video signal generated by the display controller is supplied to the display device without passing through an image processing controller that performs high-quality video processing and a second display mode in which the video signal generated by the display controller is supplied to the display device via the image processing controller.

12. The display control method according to claim 11, further comprising executing the first display mode, when the electronic apparatus is activated.

13. The display control method according to claim 11, further comprising causing the image processing controller to be in a power saving state, when the first display mode is executed.

14. The display control method according to claim 11, further comprising switching the first display mode to the second display mode, when video contents are to be displayed.

15. The display control method according to claim 11, further comprising switching the first display mode and the second display mode in accordance with an input operation.

16. The display control method according to claim 11, further comprising:
designating one of the first display mode and the second display mode to be executed when the electronic apparatus is activated; and
executing the display mode that is indicated by the designation, when the electronic apparatus is activated.

17. The display control method according to claim 11, further comprising:
designating whether the image processing controller is to be set to a power saving state or a power supply stop state when the first display mode is executed; and
causing the image processing controller to be set to a state that is indicated by the designation of the setting unit, when the first display mode is executed.

18. The display control method according to claim 11, further comprising:
designating whether or not the first display mode is to be switched to the second display mode when video contents are to be displayed; and
performing control in accordance with the designation, when video contents are to be displayed.

19. The display control method according to claim 11, further comprising:
designating whether switching between the first display mode and the second display mode is to be prohibited or not; and
performing control in accordance with the designation, when video contents are to be displayed.
